(19) United States
(12) Patent Application Publication
(10) Pub. No.: US 2004/0085678 A1
(43) Pub. Date: May 6, 2004

(54) Rotary head with small output difference and tape-medium recording and playback apparatus using the same

(75) Inventor: Atsushi Magara, Niigata-ken (JP)

Correspondence Address: Brinks Hofer Gilson & Lione, P.O. Box 10395, Chicago, IL, 60610, US

(73) Assignee: ALPS ELECTRIC CO., LTD.

(21) Appl. No.: 10/600,938

(22) Filed: Jun. 20, 2003

(30) Foreign Application Priority Data
Jun. 21, 2002 (JP) 2002-181771

(51) Int. Cl. G11B 5/52

(52) U.S. Cl. 360/271.5

(57) ABSTRACT

There is provided a rotary magnetic head including a pair of magnetic heads where a difference in voltages of output signals therebetween is made small by arranging the structure thereof such that azimuth angles of gaps of the magnetic heads are different from each other; heights of the magnetic heads from the corresponding gaps to corresponding board surfaces are set equal to each other; each of the magnetic heads is formed by mutually abutting I-type and C-type cores; the gaps lie closer to one side with respect to the width direction of the I-type and C-type cores; and, in the rotating direction of a rotating cylinder, the C-type core of one of the magnetic heads moves ahead of the I-type core of the same and the I-type core of the other magnetic head moves ahead of the C-type core of the same.

### BACKGROUND OF THE INVENTION

1. Field of the Invention

The present invention relates to a rotary head used as a video head for a video tape recorder (VTR) or the like or as a magnetic head for a high-fidelity (HiFi) recording and playback apparatus.

2. Description of the Related Art

A known rotary head for a VTR is formed by at least one pair of magnetic heads having gaps whose azimuth angles are different from each other and by the main body of a rotating cylinder for having these magnetic heads mounted thereon.

Each magnetic head is formed by a pair of mutually abutting cores having a gap interposed therebetween, and the gap is arranged so as to lie closer to one side with respect to the width direction of the cores. When the side surfaces of the cores are bonded to corresponding boards on the rotating cylinder body, heights of the gaps of the magnetic heads are usually brought into agreement with each other.

A method for manufacturing the above-mentioned magnetic heads will be described.

When the magnetic heads used for the known rotary head are to be manufactured, as shown in FIG. 11, a core block 203 composed of a integrated combination of a C-type core block 201 having a winding slot 204 and an I-type core block 202 is prepared.

The core block 203 is integrally formed such that abutting surfaces 201a and 202a of the respective C-type and I-type core blocks 201 and 202 abut against each other, having a gap layer (not shown) interposed therebetween, and corresponding pairs of pluralities of track grooves 201b and 202b formed on the corresponding abutting surfaces 201a and 202a are aligned with each other. Each of the track grooves 201b and 202b has a nonmagnetic material such as glass filled therein. Also, an upper surface 203a, to which the track grooves 201b and 202b are exposed, eventually serves as a medium sliding surface of each magnetic head.

In order to manufacture one of the pair of magnetic heads, as shown in FIG. 12A, in a state in which the C-type core block 201 lie on the right when the core block 203 is viewed from the upper surface 203a, the core block 203 is cut along cutting-plane lines shown by dotted chain lines in the drawing. Each cutting-plane line is set so as to slant to the left in the drawing at a predetermined angle with respect to the abutting surfaces 201a and 202a and also to asymmetrically divide the corresponding track grooves 201b and 202b.

Likewise, in order to manufacture the other of the pair of magnetic heads, as shown in FIG. 12B, in a state in which the core block 203 lie in the same fashion as in FIG. 12A, the core block 203 is cut along cutting-plane lines shown by dotted lines in the drawing. Each cutting-plane line is set so as to slant to the right in the drawing at a predetermined angle with respect to the corresponding abutting surfaces 201a and 202a and also to asymmetrically divide the corresponding track grooves 201b and 202b.

FIGS. 13A and 13B respectively show the one and the other magnetic heads obtained by cutting the core block 203.

As shown in FIG. 13A, one magnetic head 100 is formed by a plate-like C-type core 101 and I-type core 102 abutting against each other. The C-type core 101 has a winding slot 104, through which a coil (not shown) is wound around the cores 101 and 102. Surfaces of the C-type core 101 and the I-type core 102, which lies close to an observer in the drawing, serve as fixing surfaces 110a and 102a, respectively, and these fixing surfaces 101a and 102a are bonded to the rotating cylinder. The magnetic head 100 is fixed to the rotating cylinder such that the C-type core 101 moves ahead of the I-type core 102 in the moving direction of the head.

The magnetic head 100 has a medium sliding surface 100a. The cores 101 and 102 have a gap layer 105 composed of a nonmagnetic material, sandwiched in the abutting region therebetween, and the gap layer 105 is exposed to the medium sliding surface 100a so as to form a gap G1. The gap G1 slants at a predetermined angle with respect to the fixing surfaces 101a and 102a.

Also, as shown in a magnified illustration of FIG. 13A, the gap G1 has track grooves 106a and 106b formed at both sides thereof with respect to its width direction, and the track grooves 106a and 106b are respectively filled with nonmagnetic materials 106c and 106d composed of glass or the like. The track groove 106b on the side of the fixing surfaces 101a and 102a is more deeply formed than the track groove 106a on the opposite side of the track groove 106b.

With this structure, the gap G1 lies closer to the opposite side of the fixing surfaces 101a and 102a with respect to the width direction of the cores 101 and 102.

Likewise, as shown in FIG. 13B, another magnetic head 150 is formed by a C-type core 151 and an I-type core 152, and the C-type core 151 has a winding slot 154. The C-type core 151 and the I-type core 152 respectively have fixing surfaces 151a and 152a which are bonded to the rotating cylinder. The magnetic head 150 is fixed to the rotating cylinder such that the C-type core 151 moves ahead of the I-type core 152 in the moving direction of the head.

The magnetic head 150 has a medium sliding surface 150a. The cores 151 and 152 have a gap layer 155 sandwiched in the abutting region therebetween so as to form a gap G2. The gap G2 slants at a predetermined angle with respect to the fixing surfaces 151a and 152a and in a direction different from the direction in which the gap G1 of the magnetic head 100 slants.

Also, as shown in a magnified illustration of FIG. 13B, the gap G2 has track grooves 156a and 156b formed at both sides thereof with respect to its width direction, and the track groove 156b on the side of the fixing surfaces 151a and 152a is more deeply formed than the track groove 156a on the opposite side of the track groove 156b.

With this structure, the gap G2 lies closer to the opposite side of the fixing surfaces 151a and 152a with respect to the width direction of the cores 151 and 152.

In the rotary head, it is desirable that the strengths of output signals of the pair of magnetic heads 100 and 150 having mutually different azimuth angles agree with each other. Since the strength of an output signal of each magnetic head is largely affected by the volume of a portion mainly of the C-type core lying in the vicinity of the gap, in order to bring the strengths of output signals of the magnetic heads 100 and 150 into agreement with each other, it is preferable that the volumes of portions of the C-type cores 101 and 151 lying in the vicinities of the corresponding gaps agree with each other.

Meanwhile, as shown in FIGS. 13A and 13B, in the known magnetic heads 100 and 150, due to the positional relationships between the cutting planes of the core block 203 and the track grooves 201b and 202b, the shapes of portions M1 and M2 of the C-type cores 101 and 151 extending from the corresponding gaps G1 and G2 to planes lying 100 μm away from the corresponding gaps are different from each other. As a result, the portions M1 and M2 have volumes of, for example, 473×10⁻⁶ mm 3 and 340×10⁻⁶ mm 3, respectively; that is, the volume of the portion of the C-type core lying in the vicinity of the gap of the other magnetic head 150 shares about 72% of that of the portion of the C-type core lying in the vicinity of the gap of the one magnetic head 100. A difference in these volumes of the portions of the C-type cores becomes significant especially when the gaps G1 and G2 are arranged to lie closer to one side with the respect to the width direction of the cores.

The difference in these volumes causes a difference in voltages of output signals of the magnetic heads 100 and 150. Especially when the azimuth angles of the magnetic heads 100 and 150 become wider than +10 degrees, the difference in voltages of output signals drastically exerts an adverse effect on the characteristic of the rotary head.

### SUMMARY OF THE INVENTION

The present invention has been made in view of the above-mentioned problem. Accordingly, it is objects of the present invention to provide a rotary head having magnetic heads whose gaps lie closer to one side with respect to the width direction of cores thereof and a difference in voltages of output signals therebetween remain small even when azimuth angles thereof become large and also provide a tape-medium recording and playback apparatus using the rotary head.

In order to achieve the above objects, a rotary head and a tape-medium recording and playback apparatus according to the present invention are constructed as below.

The rotary head according to the present invention includes at least one pair of magnetic heads having gaps whose azimuth angles are different from each other; and a rotating cylinder equipped with boards for having the corresponding magnetic heads fixed thereto. The magnetic heads are arranged so as to have the same height from the corresponding gaps to board surfaces of the corresponding boards and also to be symmetric with respect to the rotating axis of the rotating cylinder. Also, each of the pair of magnetic heads is formed by an I-type core and a C-type core with a winding slot, which abut against each other having the corresponding gap interposed therebetween, and the gap lies closer to one side with respect to the width direction of the corresponding I-type and C-type cores. In addition, in the rotating direction of the rotating cylinder, the C-type core of one of the magnetic heads moves ahead of the I-type core of the same and the I-type core of the other magnetic head moves ahead of the C-type core of the same.

Since the rotary head according to the present invention is constructed such that the C-type core moves ahead of the I-type core of the one magnetic head and also the I-type core moves ahead of the C-type core of the other magnetic head in a state in which the gaps of these magnetic heads lie closer to one side with respect to the width direction of the I-type and C-type cores, portions of the above two C-type cores in the vicinities of the corresponding gaps have substantially the same shape and thus have substantially the same volume, whereby the strengths of output signals of these magnetic heads agree with each other. When this rotary magnetic head is used as a video head for a VTR or the like, the flickering and the like of an image of the VTR can be prevented.

In the above-mentioned rotary head according to the present invention, each of the magnetic heads has one and another track grooves, having the corresponding gap interposed therebetween and having different depths from each other, for regulating a track width of the gap.

In this rotary head, the magnetic heads are formed so as to have the same height from the corresponding gaps to the corresponding board surfaces, and the one and the other track grooves for regulating the track widths of the gaps of the corresponding magnetic heads are formed so as to have different depths from each other. With this structure, since the depths of the track grooves of these magnetic heads agree with each other respectively at one side and the other side, the portions of the C-type cores of the magnetic heads in the vicinities of the corresponding gaps have substantially the same shape, whereby the strengths of output signals of these magnetic heads agree with each other.

In the rotary head according to the present invention, it is preferable that, of the pair of magnetic heads, the one magnetic head have an azimuth angle equal to or greater than +10 degrees with respect to the normal of the board surface of the corresponding board and the other magnetic head have an azimuth angle equal to or less than −10 degrees with respect to the normal of the board surface of the corresponding board.

Meanwhile, it may be arranged such that the one magnetic head has an azimuth angle in the range from +10 degrees to +30 degrees and the other magnetic head has an azimuth angle in the range from −30 degrees to −10 degrees.

On the basis of the standardized values of ±30 degrees currently set for the azimuth angles in the digital video home system (VHS) recording system, the foregoing values of +30 degrees and −30 degrees are set for the sake of expediency. However, the present invention is not limited to the ranges of ±30 degrees; it will be also applicable to newly standardized values when they are revised in the future. In particular, the present invention is significantly effective when the ranges of the azimuth angles become wider; that is, when the ranges of the azimuth angles are wider than ±10 degrees, a significant difference in voltages of output signals between the pair of magnetic heads is unlikely to occur.

The tape-medium recording and playback apparatus according to the present invention includes a tape-loading path formed by a tape medium which is led out from a tape reel and is wound around any one of the above-mentioned rotary heads.

Since the tape-medium recording and playback apparatus is equipped with any one of the foregoing rotary heads, a difference in outputs of recording or playing-back signals between channels of the tape-medium recording and playback apparatus is small.

In the tape-medium recording and playback apparatus according to the present invention, the tape-loading path is preferably formed by the rotary head to be driven to rotate; two guide posts respectively disposed upstream and downstream of the rotary head, for guiding the tape medium led out from the tape reel in order to wind the tape medium around the rotary head; and a capstan disposed downstream of the rotary head, for causing the tape medium to run.

### BRIEF DESCRIPTION OF THE DRAWINGS

FIG. 1 is a schematic plan view of a tape-loading path of a tape-medium recording and playback apparatus according to an embodiment of the present invention;

FIG. 2 is a schematic plan view of a rotary magnetic head provided in the tape-medium recording and playback apparatus according to the embodiment of the present invention;

FIG. 3 is a schematic sectional view of a major part of the rotary magnetic head;

FIG. 4 is a perspective view of one of a pair of magnetic heads for forming the rotary magnetic head, including a magnified illustration in the vicinity of a gap of the one magnetic head;

FIG. 5 is a perspective view of the other magnetic head, including a magnified illustration in the vicinity of a gap of the other magnetic head;

FIG. 6 is a schematic plan view of the one and the other magnetic heads viewed from corresponding medium sliding surfaces;

FIGS. 7A and 7B are illustrations for explaining a method for manufacturing the one magnetic head;

FIGS. 8A and 8B are illustrations for explaining a method for manufacturing the other magnetic head;

FIG. 9 is a histogram illustrating a voltage distribution of output signals of rotary magnetic heads according to Example 1, measured at the frequency of 10 MHz;

FIG. 10 is a histogram illustrating a voltage distribution of output signals of rotary magnetic heads according to Comparative Example 1, measured at the frequency of 10 MHz;

FIG. 11 is an illustration for explaining a method for manufacturing known magnetic heads;

FIGS. 12A and 12B are illustrations for explaining the method for manufacturing the known magnetic heads;

FIGS. 13A and 13B are perspective views of the pair of magnetic heads for forming the known rotary magnetic head, including magnified illustrations of portions of the corresponding magnetic heads in the vicinities of corresponding gaps;

FIG. 14 is a rotary magnetic head used as a HiFi head on which the magnetic head shown in FIG. 4 is mounted;

FIG. 15 is the rotary magnetic head used as a HiFi head on which the magnetic head shown in FIG. 5 is mounted;

FIG. 16 is a histogram illustrating a voltage distribution of output signals of a rotary magnetic head according to Example 2, measured at the frequency of 1.7 MHz; and

FIG. 17 is a histogram illustrating a voltage distribution of output signals of a rotary magnetic head according to Comparative Example 2, measured at the frequency of 1.7 MHz.

### DESCRIPTION OF THE PREFERRED EMBODIMENTS

Preferred embodiments of the present invention will be described with reference to the accompanying drawings.

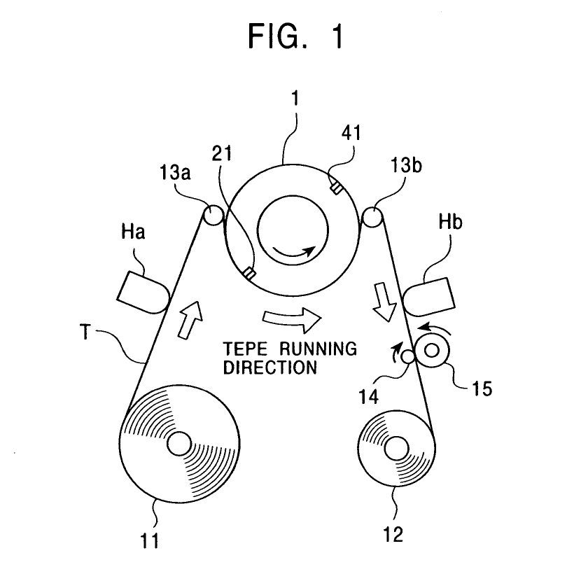

FIG. 1 is a schematic plan view of a tape-loading path of a tape-medium recording and playback apparatus according to an embodiment of the present invention. The tape-medium recording and playback apparatus shown in FIG. 1 is used for equipment such as a VTR and is equipped with a rotary head 1 to be driven to rotate by a motor, and the rotary head 1 is equipped with a pair of magnetic heads 21 and 41. In the tape-medium recording and playback apparatus shown in FIG. 1, a magnetic tape (tape medium) T led out from a feed reel 11 is guided by a guide post 13a; is wound around the rotary magnetic head 1 over a predetermined angle; is further guided by a guide post 13b; is sandwiched and held by a capstan 14 and a pinch roller 15; runs in the arrow direction shown in the drawing with a rotation of the capstan 14; and is finally taken up by a take-up reel 12. Thus, a tape-loading path including the rotary head 1 and the magnetic tape T is formed.

Also, the tape-loading path is provided with a full width erasing head Ha and an audio head Hb.

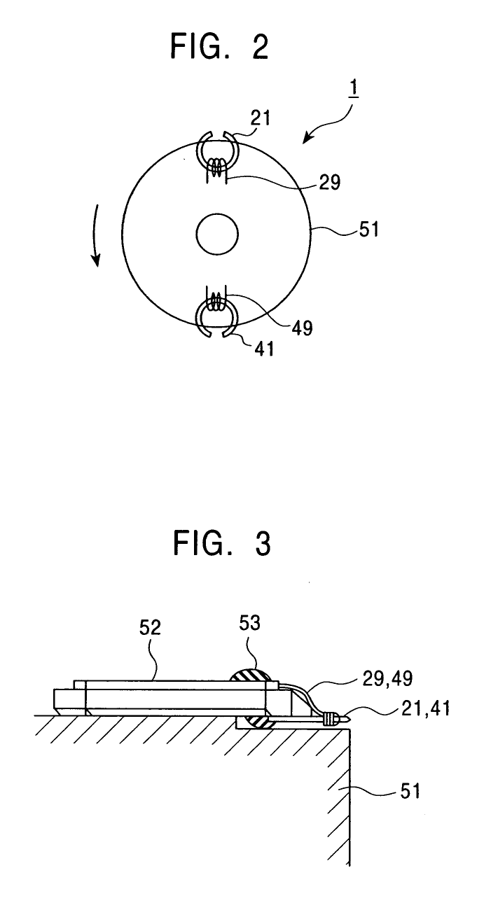

FIG. 2 illustrates the detailed structure of the rotary magnetic head 1. As shown in FIG. 2, the rotary magnetic head 1 according to the present invention is formed by the pair of magnetic heads 21 and 41 and a rotating cylinder 51 having boards (not shown) to which the magnetic heads 21 and 41 are respectively fixed. The magnetic heads 21 and 41 have coils 29 and 49, respectively. Also, the rotary magnetic head 1 is arranged so as to rotate in the arrow direction shown in the drawing. The magnetic heads 21 and 41 are arranged so as to be symmetric with respect to the rotating axis of the rotating cylinder 51.

FIG. 3 is a sectional view of a major part of the rotary magnetic head 1. As shown in FIG. 3, the rotating cylinder 51 has boards 52 fixed thereto, and the boards 52 have the foregoing magnetic heads 21 and 41 bonded to the corresponding front parts thereof. Also, the boards 52 have terminals 53 disposed thereon to which the coils 29 and 49 of the magnetic heads 21 and 41 are respectively connected.

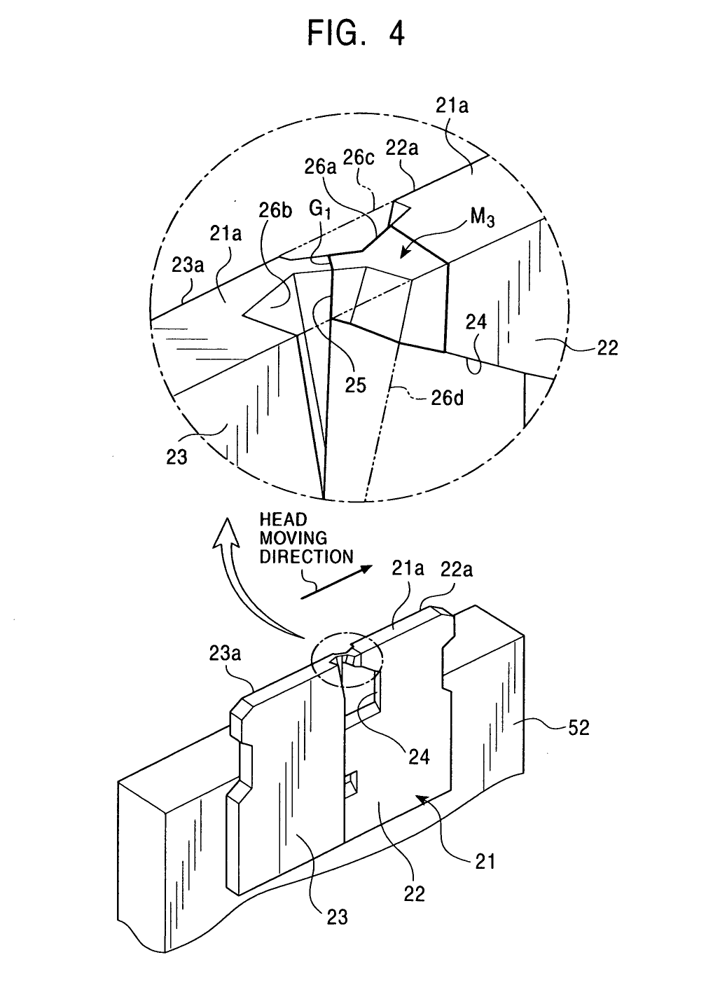

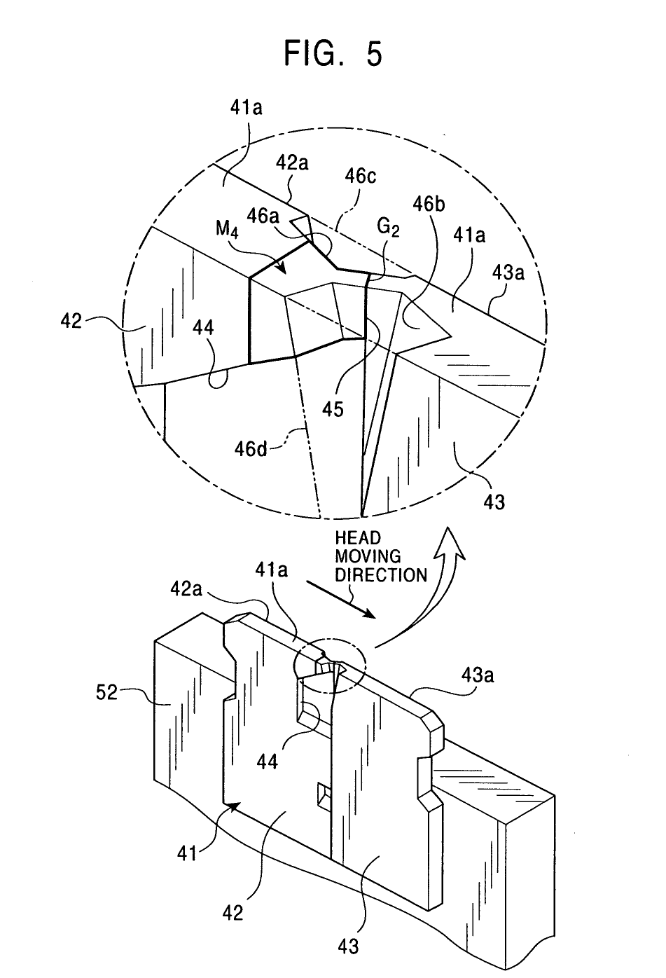

FIGS. 4 and 5 are respectively perspective views of the magnetic heads 21 and 41, including magnified illustrations in the vicinities of gaps thereof.

As shown in FIG. 4, the one magnetic head 21 is formed by a plate-like C-type core 22 and I-type core 23 which abut against each other. The C-type core 22 has a winding slot 24 formed therein, through which the coil 29 is wound around the cores 22 and 23. The surfaces of the C-type core 22 and the I-type core 23, which are not visible in the drawing, serve as fixing surfaces 22a and 23a. The magnetic head 21 is mounted on the rotating cylinder 51 by bonding the fixing surfaces 22a and 23a to the corresponding board 52. In this magnetic head 21, the C-type core 22 moves ahead of the I-type core 23 in the moving direction of the head shown by the arrow in the drawing.

Also, the magnetic head 21 has a medium sliding surface 21a having a convex curve. In addition, the cores 22 and 23 have a gap layer 25 composed of a nonmagnetic material, sandwiched in the abutting region therebetween, and the gap layer 25 is exposed to the medium sliding surface 21a so as to form a gap G1. The gap G1 slants at a predetermined angle with respect to the fixing surfaces 22a and 23a.

As shown in the magnified illustrated of FIG. 4. The gap G1 has track grooves 26a and 26b formed at both sides thereof with respect to its width direction, and the track grooves 26a 26b are respectively filled with non-magnetic materials 26cand 26d composed of glass or the like. The track groove 26b near to an observer in the drawing is more deeply formed than the track groove 26a on the side of the fixing surfaces 22a and 23a.

With the structure, the gap G1 lies closer to the side of the fixing surfaces 22a and 23a with respect to the width direction of the 22 and 23.

Likewise, as shown in FIG. 5 the other magnetic head 41 is formed by a plate-like C-type core 42 and I-type core 43 which abut against each other. The C-type core 42 has a winding slot 44 formed therein, through which the foregoing coil 49 is wound around the cores 42 and 43. The surfaces of the C-type core 42 and the I-type core 43, which are not visible in the drawing, serve as fixing surfaces 42a and 43a . The magnetic head 41 is mounted on the rotating cylinder 51 by bonding the fixing surfaces 42a and 43a to the corresponding board 52. In this magnetic head 41, the I-type core 43 moves ahead of the C-type core 42 in the moving direction of the head shown by the arrow in the drawing.

Also, the magnetic head 41 has a medium sliding surfaces 41a having a convex curve. In addition, the cores 42 and 43 have a gap layer 45 composed of a nonmagnetic material, sandwiched in the abutting region therebetween, and the gap layer 45 is exposed to the medium sliding surface 41a so as to form a gap G2. The gap G2 slants at a predetermined angle with respect to the fixing surfaces 42a and 43a.

As shown in the magnified illustration of FIG. 5, the gap G2 has track grooves 46a and 46b formed at both sides thereof with respect to its width direction, and the track grooves 46a and 46b are respectively filled with non-magnetic materials 46c and 46d composed of glass or the like. The track groove 46b near to the observer in the drawing is more deeply formed than the track groove 46a on the side of the fixing surfaces 42a and 43a.

With this structure, the gap G2 lies closer to the side of the fixing surfaces 42a and 43a with respect to the width direction of the cores 42 and 43.

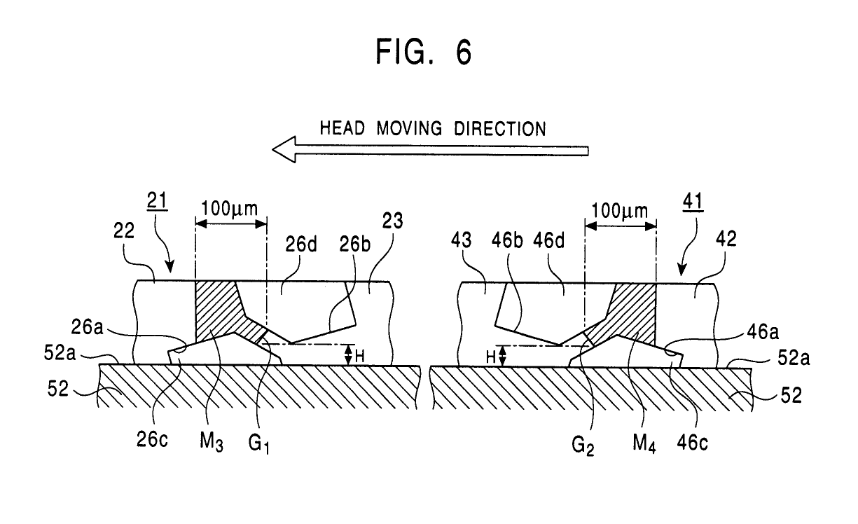

FIG. 6 is a schematic plan view of the magnetic heads 21 and 41 viewed from the medium sliding surfaces 21a and 41a, respectively.

As shown in FIG. 6, the gaps G1 and G2 of the magnetic heads 21 and 41 slant at a predetermined azimuth angle with each other. It is preferable that, of the azimuth angles of the gaps G1 and G2, the one angle (for example, of the gap G1) be equal to or greater than +10 degrees and the other angle (for example, of the gap G2) be equal to or less than −10 degrees. Also, it may be arranged such that the one angle is in the range from +10 degrees to +30 degrees and the other angle is in the range from −30 degrees to −10 degrees.

In particular, the present invention is significantly effective when the ranges of the azimuth angles become wider, that is, when the ranges of the azimuth angles are wider than ±10 degrees, a significant difference in voltages of output signals of the magnetic heads 21 and 41 is unlikely to occur.

The magnetic heads 21 and 41 are formed such that, in the moving direction of the heads, that is, in the rotating direction of the rotating cylinder 51, the C-type core 22 of the one magnetic head 21 moves ahead of the I-type core 23 of the same and also the I-type core 43 of the other magnetic head 41 moves ahead of the C-type core 42 of the same.

In addition, the magnetic heads 21 and 41 are formed so as to have the same height H from the respective gaps G1 and G2 (i.e., the centers of the track width directions of the respective gaps G1 and G2) to the board surfaces 52a.

As described above, since the magnetic heads 21 and 41 are formed so as to have the same height H, and the one azimuth angle (for example, of the gap G1) and the other azimuth angle (for example, of the gap G2) are set equal to or greater than +10 degrees and equal to or less than −10 degrees, respectively, a difference in voltages of output signals of the magnetic heads 21 and 41 is small, thereby performing the recording and the playing back of a video without problems.

As shown in the magnified illustrations in FIGS. 4 and 5 and also as shown in FIG. 6, the C-type cores 22 and 42 of the magnetic heads 21 and 41 respectively have portions M3 and M4 having substantially the same shape in the vicinities of the corresponding gaps. The shape and the volume of the portion of each C-type core in the vicinity of the corresponding gap have a large influence on magnetic parametric performances of the corresponding magnetic head. However, in the rotary head according to the present invention, even when the gaps G1 and G2 lie closer to one side with respect to the width direction of the corresponding cores, since the portions M3 and M4 of the C-type cores of the respective magnetic heads 21 and 41 are formed so as to have the same shape and volume, the magnetic heads 21 and 41 have the same magnetic parametric performances, thereby resulting in a small difference in voltages of output signals of the magnetic heads 21 and 41.

The portions M3 and M4 in the vicinities of the gaps have volumes shown by shaded areas in FIG. 6, extending from the gaps G1 and G2 to planes lying 100 μm away from the gaps G1 and G2 in the moving direction of the heads and in the counter direction, respectively. In FIGS. 4 and 5, the portions M3 and M4 in the vicinities of the corresponding gaps are respectively shown by thick lines.

A method for manufacturing the above-described magnetic heads will be described.

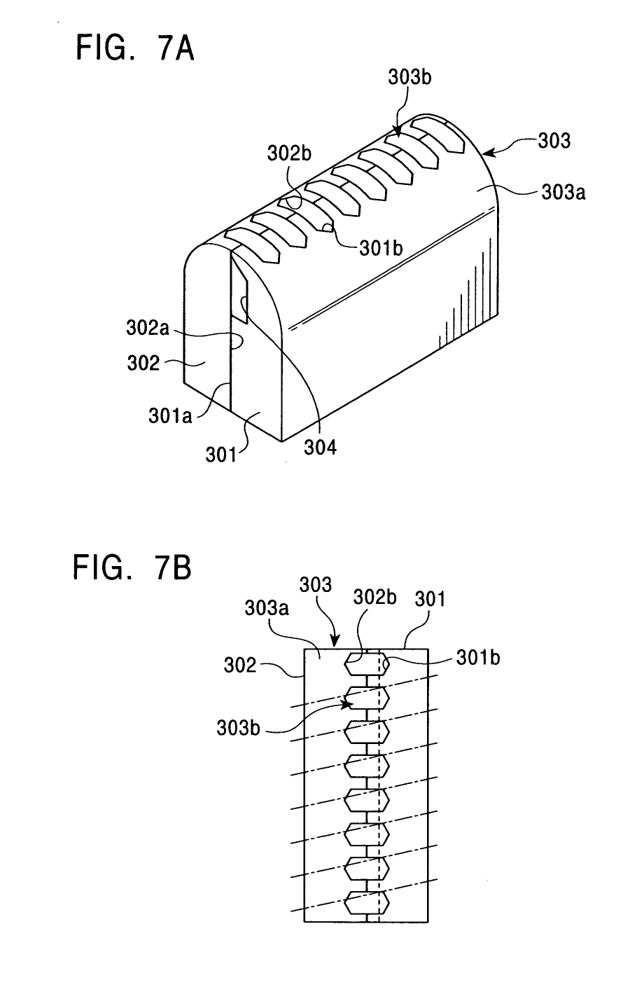

When the one magnetic head 21 shown in FIG. 4 is to be manufactured, as shown in FIG. 7A, a core block 303 composed of an integrated combination of a C-type core block 301 having a winding slot 304 formed therein and an I-type core block 302 is prepared.

The core block 303 is integrally formed such that abutting surfaces 301a and 302a of the corresponding C-type and I-type core blocks 301 and 302 abut against each other, having a gap layer (not shown) interposed therebetween, and such that corresponding pairs of pluralities of track grooves 301b and 302b respectively formed on the abutting surfaces 301a and 302a are aligned with each other. In the core block 303 formed as mentioned above, the track grooves 301b and 302b form a plurality of track holes 303b at even intervals along the abutting surfaces 301a and 302a. Each of the track holes 303b (formed by the track grooves 301b and 302b) has a nonmagnetic material such as glass filled therein. Also, an upper surface 303a, to which the track holes 303b are exposed, eventually serves as the medium sliding surface 21a of the magnetic head 21. Each portion of the core block 303 sandwiched between the adjacent track holes 303b eventually serves as the gap G1 of the magnetic head 21.

Then, as shown in FIG. 7B, in a state in which the C-type core block 301 lie on the right when the core block 303 is viewed from the upper surface 303a, the core block 303 is cut along cutting-plane lines shown by dotted chain lines in the drawing. Each cutting-plane line is set so as to slant to the left in the drawing at a predetermined angle with respect to the abutting surfaces and also to asymmetrically divide the corresponding track grooves 301b and 302b.

By cutting the core block 303 as mentioned above, the portion (the gap GI) sandwiched between the adjacent track holes 303b is formed so as to lie closer to the lower side in the drawing. According to this manufacturing method, the magnetic head 21 shown in FIG. 4 is obtained.

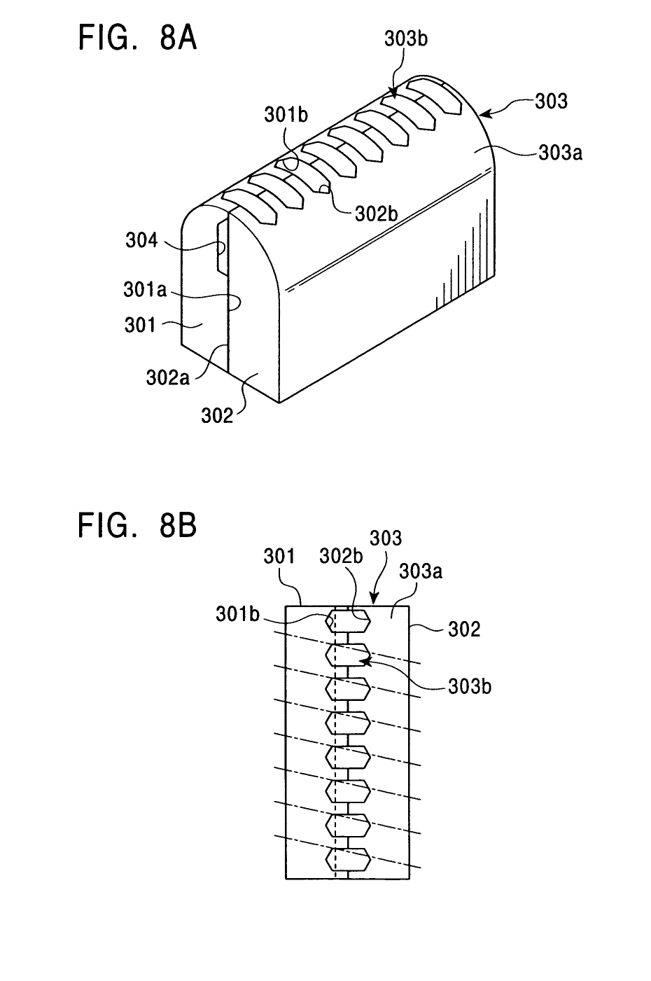

When the other magnetic head 41 shown in FIG. 5 is to be manufactured, as shown in FIG. 8A, the same core block 303 as shown in FIG. 7A is prepared. FIG. 8A illustrates a state in which the C-type core block 301 lies on the left. In other words, FIG. 8A illustrates a state in which the core block 303 is viewed from the side remote from the observer in FIG. 7A.

In this core block 303, the upper surface 303a, to which the track holes 303b are exposed, eventually serves as the medium sliding surface 41a of the magnetic head 41. Also, each portion of the core block 303 sandwiched between the adjacent track holes 303b eventually serves as the gap G2 of the magnetic head 41.

Then, as shown in FIG. 8B, in a state in which the C-type core block 301 lie on the left when the core block 303 is viewed from the upper surface 303a, the core block 303 is cut along cutting-plane lines shown by dotted chain lines in the drawing. Each cutting-plane line is set so as to slant to the right in the drawing at a predetermined angle with respect to the abutting surfaces and also to asymmetrically divide the corresponding track grooves 301b and 302b.

By cutting the core block 303 as mentioned above, the portion (the gap G2) sandwiched between the adjacent track holes 303b is formed so as to lie closer to the lower side in the drawing. According to this manufacturing method, the magnetic head 41 shown in FIG. 5 is obtained.

Thus, the magnetic head 21 or 41 according to the present invention is obtained by cutting the core block 303 in a state in which the C-type core block 301 lies on the right or on the left, respectively, when the core block 303 is viewed from the upper surface 303a.

The portions M3 and M4 of the C-type cores in the vicinities of the gaps of the magnetic heads 21 and 41 obtained as mentioned above have example volumes of 473×10⁻⁶ mm 3 and 472×10⁻⁶ mm 3, respectively, thereby resulting in substantially the same volume of the portions M3 and M4 even when the gaps G1 and G2 are formed so as to lie closer to one side with respect to the width direction of the magnetic heads.

By arranging the obtained magnetic heads 21 and 41 as shown in FIG. 6, the rotary head 1 according to the present invention is achieved. With this rotary head 1, a difference in voltages of output signals of the magnetic heads 21 and 41 is small, thereby preventing the flickering and the like of an image.

### EXAMPLES

Fifty pairs of magnetic heads, each pair having different azimuth angles from each other as shown in FIGS. 4 and 5, were prepared and mounted on corresponding rotating cylinders so as to provide fifty pieces of rotary magnetic heads according to Example 1. The recording and playing-back output characteristics of the prepared rotary magnetic heads were measured at the frequency of 10 MHz.

Of each pair of the magnetic heads used, one magnetic head (Rch) corresponding to that shown in FIG. 4 has a medium sliding surface having the radius of curvature of 8 mm, C-type and I-type cores having a width of 1 mm, a gap having a track width of 32 μm and a height H of 65 μm, an azimuth angle of +30 degrees, and a portion of the C-type core in the vicinity of the gap, having a volume of 473×10⁻⁶ mm3.

Meanwhile, the other magnetic head (Lch) corresponding to that shown in FIG. 5 has the same dimensions as those of the foregoing one magnetic head, other than an azimuth angle of −30 degrees and a portion of the C-type core in the vicinity of its gap, having a volume of 472×10⁻⁶ mm3.

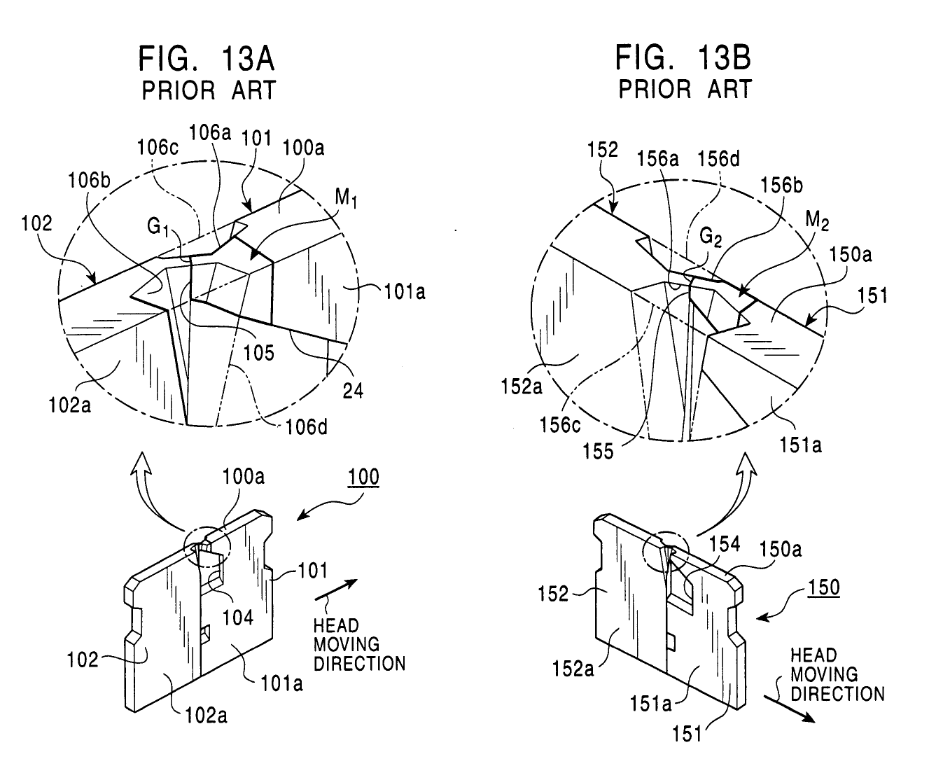

Then, fifty pairs of conventional magnetic heads, each pair having different azimuth angles from each other as shown in FIGS. 13A and 13B, were prepared and mounted on corresponding rotating cylinders so as to provide fifty pieces of rotary magnetic heads according to Comparative Example 1. The recording and playing-back output characteristics of the prepared rotary magnetic heads were measured at the frequency of 10 MHz.

Of each pair of the magnetic heads used, one magnetic head (Rch) corresponding to that shown in FIG. 13A has a medium sliding surface having the radius of curvature of 8 mm, C-type and I-type cores having a width of 1 mm, a gap having a track width of 32 μm and a height H of 65 μm, an azimuth angle of +30 degrees, and a portion of the C-type core in the vicinity of the gap, having a volume of 473×10⁻⁶ mm 3.

Meanwhile, the other magnetic head (Lch) corresponding to that shown in FIG. 13B has the same dimensions as those of the foregoing one magnetic head, other than an azimuth angle of −30 degrees and a portion of the C-type core in the vicinity of its gap, having a volume of 340×10⁻⁶ mm 3.

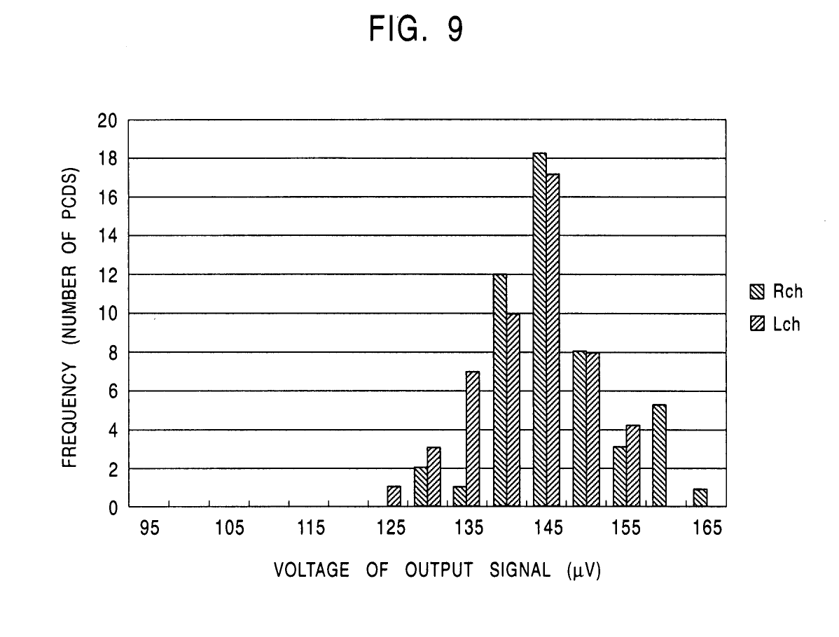

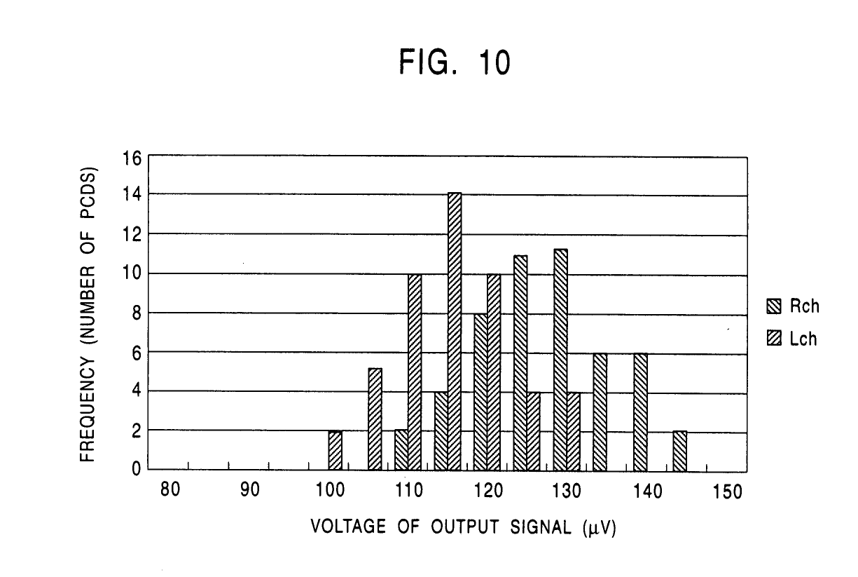

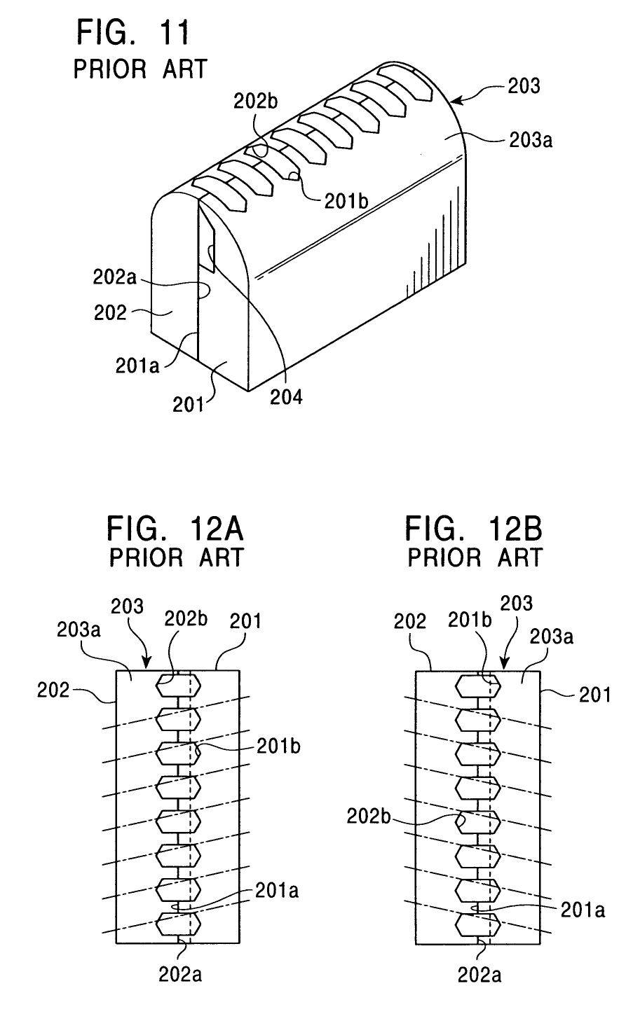

FIGS. 9 and 10 are histograms illustrating voltage distributions of output signals of the rotary magnetic heads according to Example 1 and Comparative Example 1, respectively, measured at the frequency of 10 MHz.

As shown in FIG. 9, in the rotary magnetic heads according to Example 1, the voltage distributions of output signals of the magnetic heads Rch and Lch have their centers at the same voltage of 145 μV, whereby it is turned out that the voltages of output signals of the magnetic heads Rch and Lch substantially agree with each other.

Meanwhile, as shown in FIG. 10, in the rotary magnetic heads according to Comparative Example 1, the voltage distribution of output signals of the one magnetic head Rch has its center in the range from 125 μV to 130 μV, and that of the other magnetic head Lch has its center at the voltage of 115 μV, whereby it is turned out that the voltages of output signals of the magnetic heads Rch and Lch are different from each other.

As described above, a difference in the center values of the voltage distributions of the rotary magnetic heads according to Comparative Example 1 arises. The reason for this difference is believed that a difference in the volumes of the portions of the C-type cores in the vicinities of the corresponding gaps have a large influence on magnetic parametric performances of the magnetic heads, thereby making a difference in the voltages of the outputs signals larger in Comparative Example 1 than in Example 1.

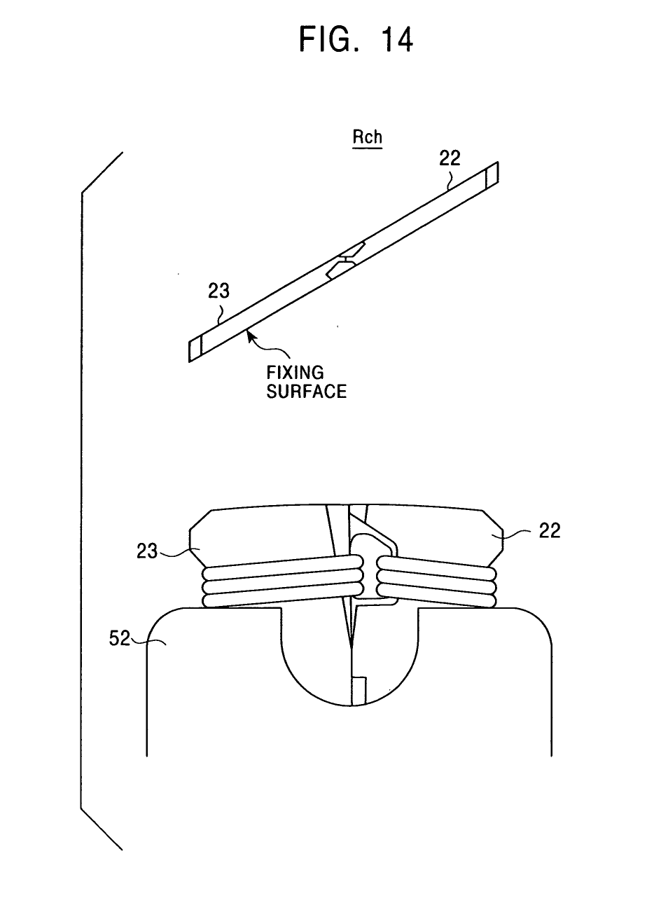

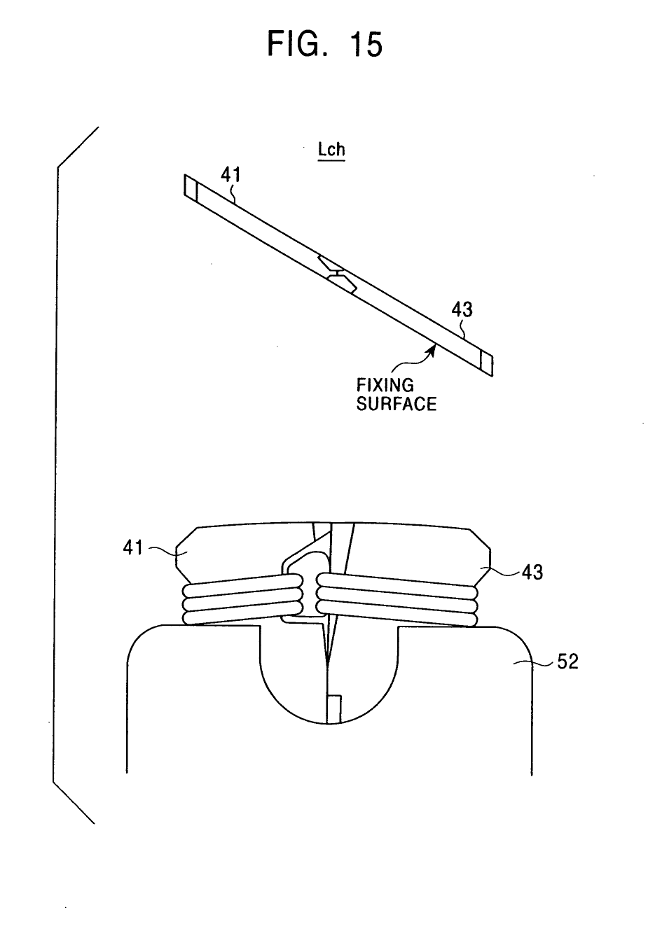

Fifty pairs of magnetic heads, each pair having different azimuth angles from each other as shown in FIGS. 4 and 5, were prepared so as to provide heads for a HiFi recording and playback apparatus (hereinafter, simply abbreviated to HiFi heads) respectively shown in FIGS. 14 and 15.

These magnetic heads were mounted on corresponding rotating cylinders so as to prepare fifty pieces of rotary magnetic heads (HiFi heads) according to Example 2. The HiFi-audio output characteristics of the prepared rotary magnetic heads were measured at the frequency of 1.7 MHz.

Of each pair of the magnetic heads used, one magnetic head (Rch) corresponding to that shown in FIG. 14 has a medium sliding surface having the radius of curvature of 8 mm, C-type and I-type cores having a width of 1 mm, a gap having a track width of 28 μm and a height H of 60 μm, an azimuth angle of +30 degrees, and a portion of the C-type core in the vicinity of the gap, having a volume of 473×10⁻⁶ mm 3.

Meanwhile, the other magnetic head (Lch) corresponding to that shown in FIG. 15 has the same dimensions as those of the foregoing one magnetic head, other than an azimuth angle of −30 degrees and a portion of the C-type core in the vicinity of its gap, having a volume of 472×10⁻⁶ mm 3.

Then, fifty pairs of conventional magnetic heads (not shown), each pair having different azimuth angles from each other as shown in FIGS. 13A and 13B, were prepared and mounted on corresponding rotating cylinders so as to provide fifty pieces of rotary magnetic heads according to Comparative Example 2. The HiFi-audio output characteristics of the prepared rotary magnetic heads were measured at the frequency of 1.7 MHz.

Of each pair of the magnetic heads used, one magnetic head (Rch) corresponding to that shown in FIG. 13A has a medium sliding surface having the radius of curvature of 8 mm, C-type and I-type cores having a width of 1 mm, a gap having a track width of 28 μm and a height H of 60 μm, an azimuth angle of +30 degrees, and a portion of the C-type core in the vicinity of the gap, having a volume of 473×10⁻⁶ mm 3.

Meanwhile, the other magnetic head (Lch) corresponding to that shown in FIG. 13B has the same dimensions as those of the foregoing one magnetic head, other than an azimuth angle of −30 degrees and a portion of the C-type core in the vicinity of its gap, having a volume of 340×10⁻⁶ mm 3.

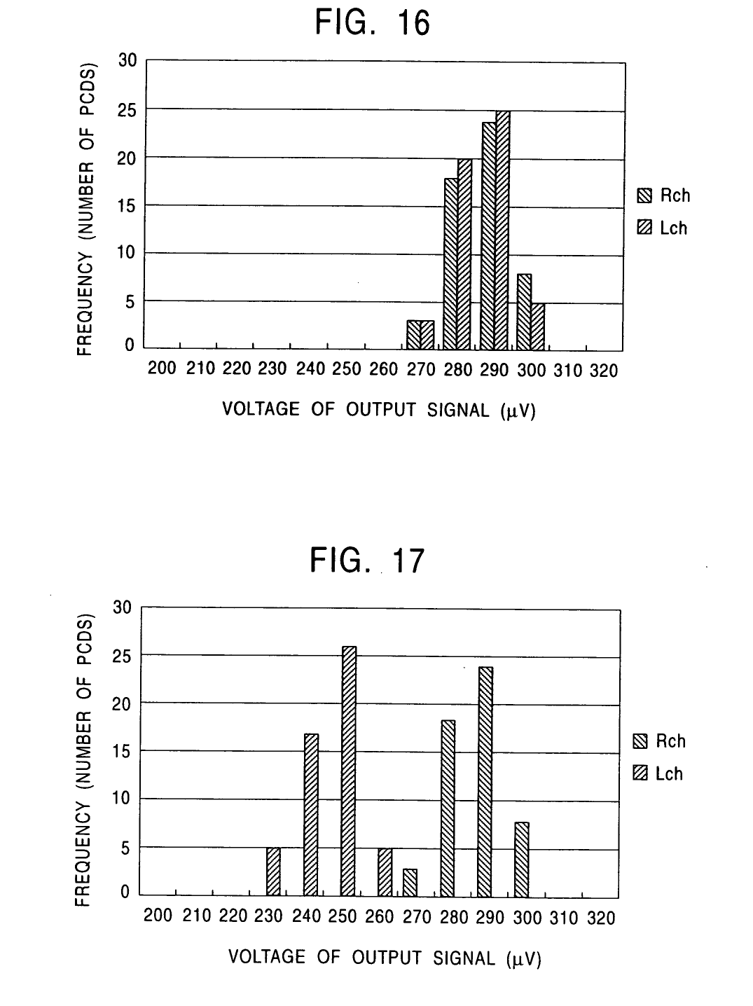

FIGS. 16 and 17 are histograms illustrating voltage distributions of output signals of the rotary magnetic heads according to Example 2 and Comparative Example 2, respectively, measured at the frequency of 1.7 MHz.

As shown in FIG. 16, in the rotary magnetic heads according to Example 2, voltage distributions of output signals of the magnetic heads Rch and Lch have their centers at the same voltage of 281 μV, whereby it is turned out that the voltages of output signals of the magnetic heads Rch and Lch substantially agree with each other.

Meanwhile, as shown in FIG. 17, in the rotary magnetic heads according to Comparative Example 2, a voltage distribution of output signals of the one magnetic head Rch has its center at the voltage of 281 μV, and that of the other magnetic head Lch has its center at the voltage of 240 μV, whereby it is turned out that the voltages of output signals of the magnetic heads Rch and Lch are different from each other.

As described above, a difference in the center values of the voltage distributions of the rotary magnetic heads according to Comparative Example 2 arises. The reason for this difference is believed that a difference in the volumes of the portions of the C-type cores in the vicinities of the corresponding gaps have a large influence on magnetic parametric performances of the magnetic heads, thereby making a difference in the voltages of the outputs signals larger in Comparative Example 2 than in Example 2.

What is claimed is:

1. A rotary head comprising: at least one pair of magnetic heads having gaps whose azimuth angles are different from each other; and a rotating cylinder comprising boards for having the corresponding magnetic heads fixed thereto, wherein the magnetic heads are arranged so as to have the same height from the corresponding gaps to board surfaces of the corresponding boards and also to be symmetric with respect to the rotating axis of the rotating cylinder,
wherein each of the pair of magnetic heads is formed by an I-type core and a C-type core with a winding slot, which abut against each other having the corresponding gap interposed therebetween, and the gap lies closer to one side with respect to the width direction of the corresponding I-type and C-type cores, and
wherein, in the rotating direction of the rotating cylinder, the C-type core of one of the magnetic heads moves ahead of the I-type core of the same and the I-type core of the other magnetic head moves ahead of the C-type core of the same.

2. The rotary head according to claim 1, wherein each of the magnetic heads has one and another track grooves, having the corresponding gap interposed therebetween and having different depths from each other, for regulating a track width of the gap.

3. The rotary head according to claim 1, wherein, of the pair of magnetic heads, the one magnetic head has an azimuth angle equal to or greater than +10 degrees with respect to the normal of the board surface of the corresponding board and the other magnetic head has an azimuth angle equal to or less than −10 degrees with respect to the normal of the board surface of the corresponding board.

4. A tape-medium recording and playback apparatus comprising a tape-loading path formed by a tape medium which is led out from a tape reel and is wound around the rotary head according to claim 1.

5. The tape-medium recording and playback apparatus according to claim 4, wherein the tape-loading path comprises the rotary head to be driven to rotate;
two guide posts respectively disposed upstream and downstream of the rotary head, for guiding the tape medium led out from the tape reel in order to wind the tape medium around the rotary head; and
a capstan disposed downstream of the rotary head, for causing the tape medium to run.
